(19) United States
(12) Patent Application Publication
(10) Pub. No.: US 2008/0140429 A1
(43) Pub. Date: Jun. 12, 2008

(54) Business Method for Promoting Sales, Satisfying Customers with Little Cost

(76) Inventor: Yuming Huang, Aurora, IL (US)

Correspondence Address: YUMING HUANG, 810 MEADOWRIDGE DRIVE, AURORA, IL, 60504, US

(21) Appl. No.: 11/561,387

(22) Filed: Nov. 18, 2006

(51) Int. Cl. G06Q 30/00

(52) U.S. Cl. 705/1

(57) ABSTRACT

The detailed information about a product is made accessible to buyers. The information helps buyers or end users to properly use, maintain, and repair the product. For example, the information about an automobile in DVD disk can be played via a built-in automobile DVD player, showing users features of the automobile, how to operate the automobile etc. This is a big value add for satisfying buyers with little cost from manufacturers. Although no product is expected to work a long time even with proper operation and maintenance, buyers hope the product work as long as possible. If ever a problem happens, buyers need the information, to know and possibly fix the problem with minimum cost. Or, buyers identify the problem to be minor, and just continue using the product without repairing the product.

Manufacturers put the detailed information about their products on (cheap) media and distribute the information with their products. This is a big value add for satisfying buyers with little cost from manufacturers. The argument is obvious: No product is expected to work a long time even with proper operation and maintenance. However, buyers hope the product bought work as long as possible. If ever a problem happens, buyers need the information regarding to their specific product, to know and possibly fix the problem with minimum cost. Or, buyers identify the problem to be no big deal via the help of the detailed information, and just continue using the product without repairing the product.

The detailed information may include (but not limited to) all the information of product design, manufacture etc. It may include information of product parts not directly manufactured by the manufacturer of the end product. It is much more detailed than the currently available user manual (which is most likely on pieces of paper or booklets). It may be conveyed by any (cheap) mass media, say, CD/DVD disks, and networks. The detailed information may be produced by product manufacturers already, for example, it is bought by auto repair shops for their own business. It may scattered here and there within departments of the product manufacturer. In order to deliver it to buyers, the manufacturer needs some compiling or editing work. Some manufacturer may not have such information available as above. If they think that is a value add, they may need to spend more effort to make the detailed information available. As for how detailed and how convenient the information is, that is up to the product manufacturer. Maybe they want to hide some trade secrets. Maybe they believe more detailed information attract more buyers. Maybe they would like different detail degrees of their product information, available to buyers at different prices.

Maybe that selling the detailed information of its product is an on-going business for the product manufacturer. That bundling the detailed information of a product with the sale of the product, does not negatively affect the on-going business. The manufacturer may limit legally the use of the detailed information to private use, just like video, computer software, etc. The customers of the above business buy the detailed information for their own business, which means they need detailed information for all products (different model, year, etc.), rather than just for a specific product.

What is claimed is:

1. Right now, when customers purchase automobiles, they only receive a concise manual book from automobile manufacturers. The book is not enough for many repair or maintenance tasks. Automobile manufacturers compile very detailed information which is sold to dealers, auto repair shops, etc. Automobile manufacturers may make the information available for auto buyers via cheap methods. For example, on CD/DVD disks that are bundled with autos sold. Or, buyers may have an account on automobile manufacturers' network computer server to access information related to the specific vehicle bought. Or, buyers may purchase heavy multi volume repair manual books at a discounted rate if automobile manufacturers want to cover printing cost. It's obvious that customers like to buy autos with detailed information available as above. On the other hand, sales of auto detailed information to dealers, auto repair shops, etc. should not be negatively affected. These professional shops need the detailed information of all the models, years, etc. Automobile manufacturers may, legally, limit auto detailed information (CD/DVD, account etc.) only for private use. Just like computer software, video, etc.

2. Similar to automobile manufacturers, house builders may compile all the detailed information regarding the house and make it available to buyers. Right now, some information is saved in government offices. Buyers only have a concise manual book. The detailed information may include (but not limit to): wall/ceiling paint color code and manufacturer contact; floor tile, carpet, wood manufacturer contact; electric wire, phone wire distribution diagram; wall stud locations; water sink repair how to; water heater operation and repair how to; furnace operation and repair how to; air conditioner operation and repair how to; humidifier operation and repair how to; sump pump operation and repair how to; dish washer operation and repair how to; range operation and repair how to.

3. For any product, if the manufacturer wants to have an advantage over its competitors, the detailed information is a value-add. Actually, the detailed information is possibly already there. What the manufacturer needs to do is to put the information on to cheap media and distribute to buyers with products. Sometimes, the manufacturer may need to spend extra effort to compile.

4. Any product in claim 3, include refrigerator, TV, computer, CD/DVD player, VCR. Manufacturers make detailed information available to buyers. The detailed information may include (but not limit to): major parts manufacturer contact; common problems and fix; operation and maintenance help. The detail degree should be as same as that of training schools or the most detailed technical manual. The detailed information may be more in detail, because it just covers a specific product.
